(19) United States
(12) Patent Application Publication
(10) Pub. No.: US 2025/0173185 A1
(43) Pub. Date: May 29, 2025

(54) DISTRIBUTED TASK PROCESSING METHOD, DISTRIBUTED SYSTEM, AND FIRST DEVICE

(71) Applicant: Cloud Intelligence Assets Holding (Singapore) Private Limited, Singapore (SG)

(72) Inventors: Tengfei LI, Beijing (CN); Liang YOU, Beijing (CN); Xin LONG, Zhejiang (CN)

(73) Assignee: Cloud Intelligence Assets Holding (Singapore) Private Limited, Singapore (SG)

(21) Appl. No.: 18/843,567

(22) PCT Filed: Feb. 28, 2023
(86) PCT No.: PCT/CN2023/078857

§ 371 Date: Sep. 3, 2024

(30) Foreign Application Priority Data
Mar. 4, 2022 (CN) 202210209756.1

(51) Int. Cl. G06F 9/50

(52) U.S. Cl. CPC G06F 9/5027

(57) ABSTRACT

A distributed task processing method, a distributed system, and a first device. A distributed task comprises at least two sub-tasks respectively executed by at least two devices in a distributed system, and the at least two devices in the distributed system comprise a first device. A processor of the first device stores in a memory result data of the execution of the first sub-tasks, such that the interaction with a disk is reduced in a data computing stage. Since the result data is stored in the memory, a network card of the first device can directly transmit the result data in the memory to a network card of a second device by means of a network, such that the interaction with the disk and the consumption of computing resources are also reduced in a data shuffling stage.

### CROSS REFERENCE TO RELATED APPLICATIONS

The present application claims the priority to Chinese Patent Application No. 202210209756.1, filed with the China Patent Office on Mar. 4, 2022, and titled “DISTRIBUTED TASK PROCESSING METHOD, DISTRIBUTED SYSTEM, AND FIRST DEVICE”, which is incorporated herein by reference in its entirety.

### TECHNICAL FIELD

Embodiments of this specification relate to the technical field of big data, and in particular, to a distributed task processing method, a distributed system, and a first device.

### BACKGROUND

With the rapid development of Internet technology, the extensive interconnection between intelligent machines and humans, as well as between machines, has generated massive amounts of big data. In the face of big data on a massive data scale, it is necessary to jointly maintain the massive data through a distributed system. The distributed system includes a plurality of nodes, each of which maintains a part of the entire data. In the distributed system, when execution of a task needs to utilize data stored in different nodes, the task can be divided into a plurality of sub-tasks. Each sub-task is respectively scheduled to be executed in a node where needed data is stored. This task collaboratively executed by the plurality of nodes can be referred to as a distributed task.

### SUMMARY

Embodiments of this specification provide a distributed task processing method, a distributed system, and a first device.

According to a first aspect of the embodiments of this specification, there is provided a distributed task processing method, wherein a distributed task includes at least two sub-tasks respectively executed by at least two devices in a distributed system, wherein the at least two devices of the distributed system include a first device; the method including:
reading, by a processor of the first device, data in a memory of the first device to execute a first sub-task corresponding to the first device, obtaining and storing result data of the first sub-task in the memory of the first device; and
transmitting, by a network card of the first device, the result data of the first sub-task in the memory of the first device to a network card of a second device of the distributed system through network, such that the network card of the second device writes the result data of the first sub-task in a memory of the second device.

In some examples, that the network card of the second device writes the result data of the first sub-task in the memory of the second device includes:
reading, by a processor of the second device, the result data in the memory of the second device to execute a second sub-task corresponding to the second device; and/or
transmitting, by the network card of the second device, the result data in the memory of the second device to a network card of a third device in the distributed system through network, such that the third device utilizes the result data to execute a third sub-task corresponding to the third device.

In some examples, after the network card of the second device writes the result data of the first sub-task in the memory of the second device, the method further includes:
sequentially writing, by the processor of the second device, the result data in the memory of the second device in a disk of the second device.

In some examples, after sequentially writing, by the processor of the second device, the result data in the memory of the second device in the disk of the second device, the method further includes:
deleting, by the processor of the second device, the result data in the memory of the second device; and
sequentially reading, after the processor of the second device receives a result data sending instruction, the result data from the disk of the second device to the memory of the second device, such that the network card of the second device transmits the result data in the memory of the second device to the network card of the third device in the distributed system through network.

In some examples, a storage area of the memory of the first device includes a sub-area for storing application data; the result data of the first sub-task is stored in the sub-area of the memory; and transmitting, by the network card of the first device, the result data of the first sub-task in the memory of the first device to the network card of the second device in the distributed system through network includes:
transmitting, by the network card of the first device, the result data in the sub-area of the memory to the network card of the second device through remote direct access technology.

According to a second aspect of the embodiments of this specification, there is provided a distributed system for executing a distributed task, wherein the distributed system includes at least two devices including a first device; the distributed task includes at least two sub-tasks respectively executed by the at least two devices;
a processor of the first device is used for reading data in a memory of the first device to execute a first sub-task corresponding to the first device, obtaining and storing result data of the first sub-task in the memory of the first device;
a network card of the first device is used for transmitting the result data of the first sub-task in the memory of the first device to a network card of a second device of the distributed system through network; and
a network card of the second device is used for receiving the result data of the first sub-task and writing the result data of the first sub-task in a memory of the second device.

In some examples, a processor of the second device is used for reading the result data in the memory of the second device to execute a second sub-task corresponding to the second device; and/or
the network card of the second device is used for transmitting the result data in the memory of the second device to a network card of a third device in the distributed system through network, such that the third device utilizes the result data to execute a third sub-task corresponding to the third device.

In some examples, the processor of the second device is further used for sequentially writing the result data in the memory of the second device in a disk of the second device.

In some examples, the processor of the second device is further used for deleting the result data in the memory of the second device; and sequentially reading, after receiving a result data sending instruction, the result data from the disk of the second device to the memory of the second device, such that the network card of the second device transmits the result data in the memory of the second device to the network card of the third device in the distributed system through network.

In some examples, a storage area of the memory of the first device includes a sub-area for storing application data; and the result data of the first sub-task is stored in the sub-area of the memory, and
the network card of the first device is further used for transmitting the result data in the sub-area of the memory to the network card of the second device through remote direct access technology.

According to a third aspect of the embodiments of this specification, there is provided a first device of a distributed system for executing a distributed task, wherein the distributed system includes at least two devices including the first device; the distributed task includes at least two sub-tasks respectively executed by the at least two devices; the first device includes:
a processor;
a memory for storing processor executable instructions;
a network card; and
a memory;
wherein the processor is configured to read data in the memory of the first device to execute a first sub-task corresponding to the first device, obtain and store result data of the first sub-task in the memory of the first device; and
the network card is configured to transmit the result data of the first sub-task in the memory of the first device to a network card of a second device of the distributed system through network, such that the network card of the second device writes the result data of the first sub-task in a memory of the second device.

According to a fourth aspect of the embodiments of this specification, there is provided a computer program product including a computer program which, when executed by a processor, implements steps of the method according to any example of the above first aspect.

According to a fifth aspect of the embodiments of this specification, there is provided a computer readable storage medium having computer instructions stored thereon which, when executed, execute the method according to any example of the above first aspect.

It should be understood that both the foregoing general description and the following detailed description are exemplary and explanatory only and cannot limit the embodiments of this specification.

### BRIEF DESCRIPTION OF THE DRAWINGS

The drawings here are incorporated into the specification and constitute a part of the embodiments of this specification, which show embodiments consistent with the embodiments of this specification, and are used, together with the specification, to explain the principles of the embodiments of this specification.

FIG. 1 is a schematic diagram of a distributed system shown according to an embodiment of the embodiments of this specification.

FIG. 2 is a flow chart of a distributed task processing method shown according to an embodiment of the embodiments of this specification.

FIG. 3 is a schematic diagram of a Spark architecture shown according to an embodiment of the embodiments of this specification.

FIG. 4 is a flow chart of a distributed task processing method shown according to another embodiment of the embodiments of this specification.

FIG. 5(a) is a schematic structural diagram of a distributed system shown according to an embodiment of the embodiments of this specification.

FIG. 5(b) is a schematic structural diagram of a distributed system shown according to another embodiment of the embodiments of this specification.

FIG. 6 is a hardware structural diagram of a first device of a distributed system shown according to an embodiment of the embodiments of this specification.

### DETAILED DESCRIPTION

Exemplary embodiments will be illustrated in detail here, examples of which are indicated in the drawings. When the following description refers to the drawings, unless otherwise indicated, the same numerals in different drawings indicate the same or similar elements. The implementations described in the following exemplary embodiments do not represent all implementations consistent with the embodiments of this specification. Rather, they are merely instances of apparatuses and methods consistent with some aspects of the embodiments of this specification, as detailed in the appended claims.

The terms used in the embodiments of this specification are only for the purpose of describing particular embodiments, and are not intended to limit the embodiments of this specification. Singular forms of “a/an”, “the” and “this” used in the embodiments of this specification and the appended claims are also intended to include the plural forms, unless otherwise clearly indicated in the context. It should also be understood that the term “and/or” used herein refers to and includes any or all possible combinations of one or more associated listed items.

It should be understood that although various information may be described employing terms such as first, second, and third in the embodiments of this specification, such information should not be limited to these terms. These terms are only used to distinguish information of the same type from each other. For instance, without departing from the scope of the embodiments of this specification, a first information can also be referred to as a second information, and similarly, the second information can also be referred to as the first information. Depending on the context, the word “if” as used here can be explained as “as” or “when” or “determining . . . in response to . . . ”.

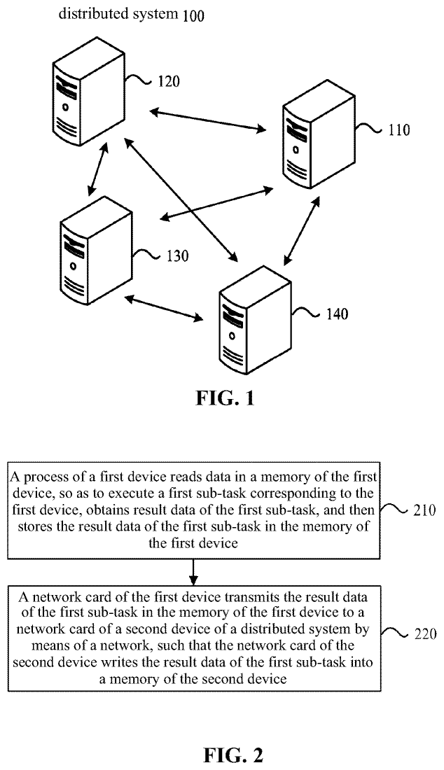

With the rapid development of Internet technology, the extensive interconnection between intelligent machines and humans, as well as between machines, has generated massive amounts of big data. In the face of big data on a massive data scale, it is necessary to jointly maintain the massive data through a distributed system. The distributed system can be implemented based on a cluster of machines. As an instance, FIG. 1 shows a schematic diagram of a distributed system. A distributed system 100 can include a plurality of nodes, such as nodes 110-140 shown in the figure. Each node can store a part of data and maintain the stored data, respectively. On the one hand, in the distributed system, when execution of a task needs to utilize data stored in different nodes, the task can be divided into a plurality of sub-tasks. Each sub-task is respectively scheduled to be executed in a node where needed data is stored. On the other hand, when executing tasks such as data storage, management, and analysis, since the complexity of the tasks greatly exceeds the processing capability of a single device, a complex task can be divided into a plurality of sub-tasks, which are allocated to a plurality of nodes for respective execution. The above task collaboratively executed by the plurality of nodes can be referred to as a distributed task. Sub-tasks divided in the distributed task can be a plurality of sub-tasks processed synchronously and in parallel; or part of the sub-tasks can be executed on the basis of execution results of the other part of the sub-tasks, that is, there is a sequential execution order between the sub-tasks, and the sub-tasks are a plurality of sub-tasks processed asynchronously. Different nodes can be different from each other in hardware configuration, for instance, different nodes own different calculating capabilities or data receiving and sending capabilities. According to the attributes of the sub-tasks and/or the data needed to execute the sub-tasks, the sub-tasks can be delivered to different nodes for processing

In a process where a plurality of nodes collaboratively executes a distributed task, since each node is only responsible for calculation of a part of data, data shuffle between nodes is an indispensable process. In related technologies, in a process where a processor of a node executes an assigned sub-task, intermediate data of the sub-task is read and written in a memory and a disk for multiple times. After obtaining a respective result data of the sub-task, the processor can store the result data from the memory into a storage device such as the disk. In a data shuffling stage, the processor of the node reads the result data in the disk into the memory through random input/output (I/O), and then sends the result data to a node of a next sub-task through a network protocol such as a TCP/IP protocol.

However, the random I/O of the disk in the data shuffling stage consumes disk performance greatly, and especially tends to deplete the input/output operations per second (IOPS) of the disk. Computing resources occupied by data shuffle are relatively large, and how to reduce the computing resources consumed during data shuffling is a technical problem to be solved urgently in the field.

That is, in a process of executing a distributed task, since each node is only responsible for calculation of a part of data, data shuffle between nodes is an indispensable process. However, in related technologies, computer resources occupied by a data shuffling process are relatively large, and how to reduce the computing resources consumed by the data shuffling process is a technical problem to be solved urgently in the field.

To this end, embodiments of this specification provide a distributed task processing method, a distributed system, and a first device to reduce computing resources consumed in a data shuffling process and improve the execution efficiency of distributed tasks. Specifically, an embodiment of this specification proposes a distributed task processing method, where this distributed task is executed by a distributed system. The distributed system includes at least two devices, and the distributed task includes at least two sub-tasks. The at least two sub-tasks are respectively executed by the at least two devices included in the distributed system. Devices for executing the sub-tasks at least include a first device. The above method includes the steps described in FIG. 2:
at step 210, reading, by a processor of the first device, data in a memory of the first device to execute a first sub-task corresponding to the first device, obtaining and storing result data of the first sub-task in the memory of the first device; and
at step 220: transmitting, by a network card of the first device, the result data of the first sub-task in the memory of the first device to a network card of a second device of the distributed system through network, such that the network card of the second device writes the result data of the first sub-task in a memory of the second device.

The step 210 and step 220 can be executed by different execution entities. As an instance, the step 210 can be executed by the processor of the first device, and the step 220 can be executed by the network card of the first device.

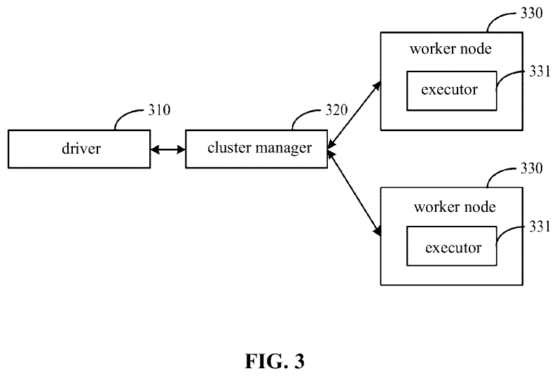

The distributed system can be the distributed system 100 as shown in FIG. 1, and the first device and the second device can be any node of the nodes 110-140. The distributed system can be equipped with a big data storage and computing architecture based on in-memory computing, such as a Spark computing architecture (hereinafter referred to as Spark). Taking Spark as an instance, a schematic diagram of a Spark architecture is shown in FIG. 3. The Spark architecture includes a Spark driver 310, a cluster manager 320, and one or more worker nodes 330 (two in FIG. 3 as an instance). A worker node 330 includes an executor 331. The Spark driver 310 can be installed on a node of the distributed system as an execution entrance of a Spark program, which is used to build a directed acyclic graph (DAG), apply for cluster resources, create an accumulator, and broadcast variables; part of the nodes in the distributed system can serve as the cluster manager 320 to provide the program with external services of computing resources; the other part of the nodes in the distributed system can serve as the worker node 330, which is a worker node in the cluster and is responsible for task computing; the executor 331 is one process in the worker node 330, which is used to manage task computing on one or more CPU threads.

In general, processing of data by a node can include data computation and data shuffle. The data computation is to utilize data stored in this node to execute a scheduled sub-task and obtain result data corresponding to this sub-task. The data shuffle is to transmit the result data of this sub-task to other nodes. For a distributed system equipped with an in-memory computing architecture such as Spark, in a data computing process, that is, when a first sub-task is executed, a first device can, based on in-memory computing, store result data of the first sub-task in a memory, instead of being stored in a disk. Compared with an architecture based on in-disk computing, the architecture based on in-memory computing reduces the interaction with the disk in the computing process, and therefore has higher throughput and lower access latency, that is, it reduces the interaction with the disk from a stage of data computing, and saves computing resources.

Subsequently, a network card of the first device transmits the result data stored in the memory to a network card of a second device through network, such that the network card of the second device writes the result data in a memory of the second device. To this point, a process of data shuffling between the first device and the second device has been completed.

According to the distributed task processing method provided in the embodiment of this specification, on the one hand, the first device stores the result data of the first sub-task in the memory in the data computing stage, reducing the interaction with the disk. On the other hand, since the result data of the first sub-task is stored in the memory in the computing stage, the network card of the first device can directly transmit the result data stored in the memory to the network card of the second device through network in the data shuffling stage, such that the network card of the second device writes the result data in the memory of the second device. In both the computing stage and the data shuffling stage, the interaction with the disk and the consumption of computing resources are reduced. Therefore, the execution duration of the distributed task is shortened, which facilitates execution of a distributed task having a high real time requirement.

When executing the first sub-task, a processor of the first device reads needed data from the memory of the first device. In some embodiments, the needed data can be stored in the disk or another storage device prior to being loaded to the memory of the first device.

In some embodiments, the first device and the second device can be nodes in the distributed system for executing sub-tasks included in the distributed task. As such, after the network card of the second device writes the result data of the first sub-task in the memory of the second device, a processor of the second device can read the result data of the first sub-task in the memory of the second device to execute a second sub-task corresponding to the second device.

In some embodiments, in order to prevent data loss, while the network card of the second device writes the result data of the first sub-task in the memory of the second device, the processor of the second device can further sequentially write the result data of the first sub-task in a disk of the second device.

In some embodiments, after the result data of the first sub-task is all written in the memory and a hard disk of the second device, if the second sub-task does not meet an execution condition, the processor of the second device can delete the result data of the first sub-task in the memory of the second device. Furthermore, when the second sub-task meets the execution condition, the processor of the second device sequentially reads the result data of the first sub-task from the disk to the memory of the second device to execute the second sub-task. The execution condition can include but is not limited to: an execution time is reached and/or the second device stores all data needed to execute the task.

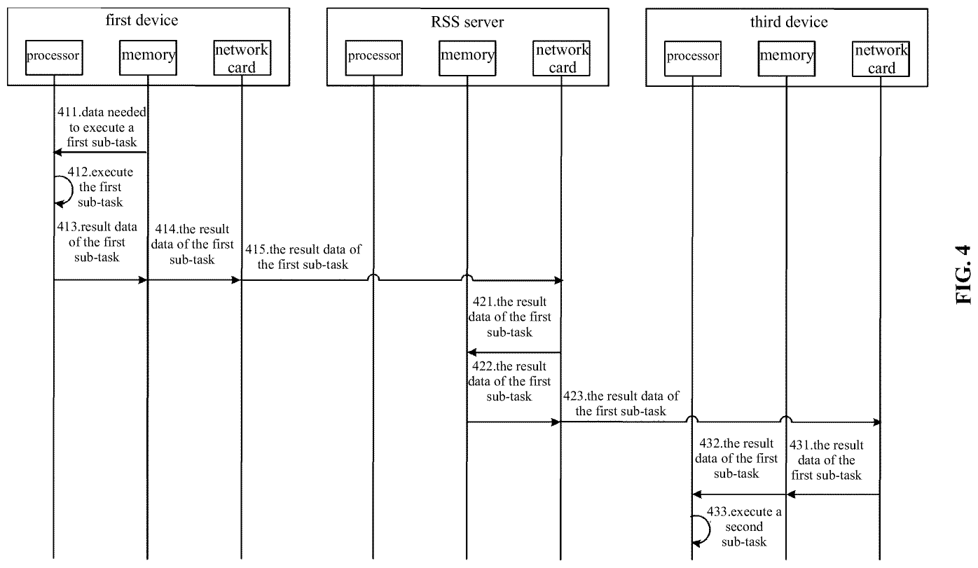

In a case where both the first device and the second device are nodes for executing a sub-task, both the data computing stage and the data shuffling stage are completed in the first device. However, the data computing stage and the data shuffling stage have different requirements for the hardware configuration of the nodes. For instance, a node that performs data computation will have a higher requirement on calculating capability, while a node that performs data shuffle has a higher requirement on data receiving and sending capability. If the first device undertakes data computation and data shuffle at the same time, higher requirements will be placed on both calculating capability and data receiving and sending capability of the first device, which brings a certain burden to the first device. As such, in some embodiments, decoupling of data computation and data shuffle can be implemented employing a remote shuffle service (RSS). As shown in FIG. 4, the first device can be a node in the distributed system for executing a sub-task included in the distributed task; and the second device can be a server for storing result data of the sub-task, for instance, an RSS server. In addition to the result data of the first sub-task, the second device can further store result data of sub-tasks executed by other nodes in the distributed system. The distributed system further includes a third device that can be a node for executing a sub-task included in the distributed task. As such, the distributed task processing method of this embodiment can include the steps shown in FIG. 4:
at step 411, reading, by a processor of a first device, data needed to execute a first sub-task from a memory of the first device;
at step 412, executing, by the processor of the first device, the first sub-task, and obtaining result data of the first sub-task;
at step 413, storing, by the processor of the first device, the result data of the first sub-task in a memory of the first device;
at step 414, reading, by a network card of the first device, the result data of the first sub-task from the memory of the first device;
at step 415, transmitting, by the network card of the first device, the result data of the first sub-task to a network card of an RSS server through network;
at step 421, writing, by the network card of the RSS server, the result data of the first sub-task in a memory of the RSS server;
at step 422, reading, by the network card of the RSS server, the result data of the first sub-task from the memory of the RSS server;
at step 423, transmitting, by the network card of the RSS server, the result data of the first sub-task to a network card of a third device through network;
at step 431, writing, by the network card of the third device, the result data of the first sub-task in a memory of the third device;
at step 432, reading, by a processor of the third device, the result data of the first sub-task from the memory of the third device; and
at step 433, utilizing, by the processor of the third device, the result data of the first sub-task to execute a third sub-task corresponding to the third device.

In some embodiments, the RSS server can execute the step 422 after receiving a sending instruction for the result data of the first sub-task.

In some embodiments, in order to prevent data loss, while the RSS server executes the step 421, a processor of the RSS server can further sequentially write the result data of the first sub-task in a disk of the RSS server.

In some embodiments, after the result data of the first sub-task is written in the memory and the hard disk of the RSS server, if the RSS server does not receive the sending instruction for the result data of the first sub-task, the processor of the RSS server can delete the result data of the first sub-task in the memory of the RSS server. Furthermore, when receiving the sending instruction for the result data of the first sub-task, the processor of the RSS server then sequentially reads the result data of the first sub-task from the disk to the memory of the RSS server, and the RSS server subsequently executes the step 422.

In some embodiments, after executing the third sub-task, the third device can send result data of the third sub-task to the RSS server for storage, so as to be invoked by other nodes in the distributed system. For a process of sending the result data of the third sub-task, reference can be made to the above embodiment, which will not be repeated in the embodiments of this specification.

As such, after the first device has executed the first sub-task, the result data of the first sub-task is stored in the RSS server. When the third device needs to utilize the result data of the first sub-task, the third device can request the result data from the RSS server without performing data interaction with the first device. For the first device, when the first device executes a plurality of sub-tasks, the first device can send the result data of the plurality of sub-tasks all to the RSS server, and utilize the RSS server to send the result data of the plurality of sub-tasks to a next node. Therefore, the first device does not need to perform data shuffle with a plurality of nodes, which greatly reduces the amount of data received and sent by the first device, thereby decoupling data computation from data shuffle. Since the first device only needs to undertake data computation work, more attention can be paid to computing capability in the hardware configuration of the first device; while the second device mainly undertakes data shuffle, and can pay more attention to data receiving and sending capability in the hardware configuration.

As described above, in a traditional data shuffling process, result data is typically sent to a next node through a network protocol such as a TCP/IP protocol. A storage area of memory can include a sub-area for storing application data, which is also referred to as a user mode memory, or a user space memory; and further include a sub-area for storing operating system data, which is also referred to as a kernel mode memory, or a kernel space memory. In a traditional TCP/IP technology, a data sending device needs to first read to-be-transmitted data from a disk into a user mode memory, then a CPU of the data sending device copies the to-be-transmitted data to a kernel mode memory, and later a network card copies the to-be-transmitted data in the kernel mode memory into its own buffer, processes and sends the same to a data receiving device through a physical link. Copying the to-be-transmitted data for multiple times depends on the CPU to execute, which consumes the CPU greatly. To this end, in some embodiments, a process of transmitting the result data of the first sub-task from the first device to the second device can include transmitting, by the network card of the first device, the result data in the user mode memory to the network card of the second device through remote direct access technology (RDMA). Correspondingly, the network cards of the first device and the second device can be an RDMA network card. The RDMA technology is a new direct memory access technology. Utilizing the RDMA technology, a network card of the data sending device can directly copy the to-be-transmitted data in the user mode memory to its own buffer. After the to-be-transmitted data is assembled into packets at layers, it is sent to a network card of the data receiving device through the physical link. After receiving the data, the network card of the data receiving device can directly copy the received data to the user mode memory after stripping off packet headers and check codes of the layers. Therefore, the RDMA technology can directly access data from a memory of one device to that of another, bypassing copying on the kernel mode memory, system calls, and CPU context switching, thereby saving the overhead of the TPC/IP protocol. Compared with the traditional TCP/IP technology, the RDMA technology greatly reduces the consumption of the CPU and shortens the transmission delay in a data transmission process.

In this embodiment, the second device can be the above RSS server, and the distributed system further includes a third device that can be a node for executing a sub-task included in the distributed task. In this embodiment, the distributed task processing method can include the steps shown above in FIG. 4. As such, in this embodiment, the network card of the first device can transmit the result data in the user mode memory to the network card of the RSS server through the RDMA technology. The network card of the RSS server can write the result data of the first sub-task in the memory of the RSS server. Subsequently, after receiving a result data sending instruction, the network card of the RSS server can read the result data of the first sub-task from the memory of the RSS server, and transmit the result data to the network card of the third device through the RDMA technology. The network card of the third device writes the result data of the first sub-task in the memory of the third device. In the field of distributed computing, in a data shuffling process of many memory-based computing frameworks such as Spark, since there remains a process of interaction of data between memory and disk, this seriously consumes CPU, memory, disk and network resources, resulting in waste of resources. However, this embodiment uses the RSS technology to extend a data shuffling process to a remote end (RSS server), and incorporates the RDMA technology to solve the problem of resource consumption in the data shuffling process.

According to the distributed task processing method provided in this embodiment, the network card of the first device can directly read intermediate result data from the user mode memory, and the data transmission bypasses the kernel (Kernel Bypass) to implement zero copy. The network card sends the intermediate result data to the network card of the second device based on the RDMA technology. After receiving the intermediate result data, the network card of the second device can directly write the data in the user mode memory of the second device. On the one hand, since the intermediate result data is read directly from the memory, the interaction with the disk is reduced; on the other hand, the intermediate result data can be directly transmitted from the user mode memory to the network card without being processed by the CPU, and the consumption of the CPU is therefore reduced in the data shuffling process, saving computing resources.

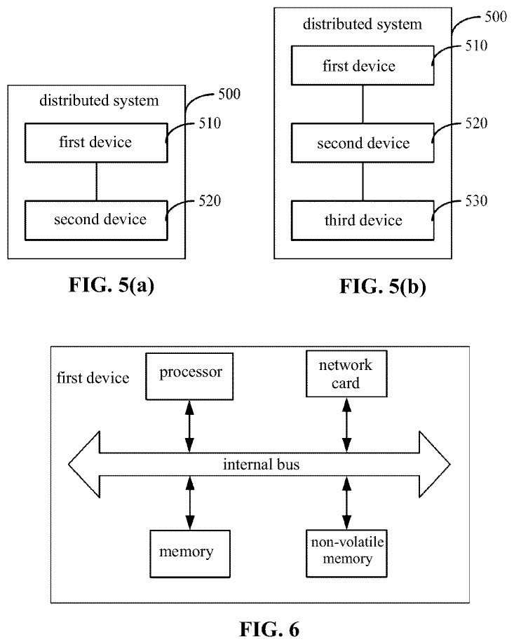

Based on the distributed task processing method described in any of the above embodiments, an embodiment of this specification further provides a distributed system for executing a distributed task. The distributed task includes at least two sub-tasks. The at least two sub-tasks are respectively executed by at least two devices included in the distributed system. As shown in FIG. 5(a) to FIG. 5(b), a distributed system 500 at least includes a first device 510 for executing the above sub-tasks, and further includes a second device 520.

A processor of the first device 510 is used for reading data in a memory of the first device 510 to execute a first sub-task corresponding to the first device 510, obtaining and storing result data of the first sub-task in the memory of the first device 510.

A network card of the first device 510 is used for transmitting the result data of the first sub-task in the memory of the first device 510 to a network card of a second device 520 of the distributed system 500 through network.

A network card of the second device 520 is used for receiving the result data of the first sub-task and writing the result data of the first sub-task in a memory of the second device 520.

In some embodiments, a processor of the second device 520 is used for reading the result data in the memory of the second device 520 to execute a second sub-task corresponding to the second device 520.

In some embodiments, as shown in FIG. 5(b), the distributed system 500 further includes a third device 530. The network card of the second device 520 is used for transmitting the result data in the memory of the second device to a network card of the third device 530 in the distributed system through network, such that the third device 530 utilizes the result data to execute a third sub-task corresponding to the third device 530.

In some embodiments, the processor of the second device 520 is further used for sequentially writing the result data in the memory of the second device 520 in a disk of the second device 520.

In some embodiments, the processor of the second device 520 is further used for deleting the result data in the memory of the second device 520; and sequentially reading, after receiving a result data sending instruction, the result data from the disk of the second device 520 to the memory of the second device 520, such that the network card of the second device 520 transmits the result data in the memory of the second device 520 to the network card of the third device 530 in the distributed system through network.

In some embodiments, a storage area of the memory of the first device 510 includes a sub-area for storing application data; the result data of the first sub-task is stored in the sub-area of the memory; and the network card of the first device 510 is further used for transmitting the result data in the sub-area of the memory to the network card of the second device 520 through remote direct access technology.

Based on the distributed task processing method described in any of the above embodiments, an embodiment of this specification further provides a first device of a distributed system as shown in the schematic structural diagram of FIG. 6. The distributed system is used for executing a distributed task, and includes at least two devices that include the first device; and the distributed task includes at least two sub-tasks respectively executed by the at least two devices. As in FIG. 6, at a hardware level, the first device includes a processor, an internal bus, a network card, a memory, and a non-volatile memory, and certainly, may further include hardware needed by other services. The processor reads a corresponding computer program from the non-volatile memory into the memory and then runs it, and the processor is configured to read data in the memory of the first device to execute a first sub-task corresponding to the first device, obtain and store result data of the first sub-task in the memory of the first device. The network card is configured to transmit the result data of the first sub-task in the memory of the first device to a network card of a second device of the distributed system through network, such that the network card of the second device writes the result data of the first sub-task in a memory of the second device.

Based on the distributed task processing method described in any of the above embodiments, an embodiment of this specification further provides a computer program product including a computer program which, when executed by a processor, can be used for executing the distributed task processing method described in any of the above embodiments.

Based on the distributed task processing method described in any of the above embodiments, an embodiment of this specification further provides a computer storage medium having a computer program stored which, when executed by a processor, can be used for executing the distributed task processing method described in any of the above embodiments.

The technical solutions provided in the embodiments of this specification may include the following beneficial effects:

The embodiments of this specification provide a distributed task processing method, a distributed system, and a first device, where a distributed task includes at least two sub-tasks respectively executed by at least two devices in the distributed system, and the at least two devices of the distributed system include the first device. A processor of the first device stores in a memory result data of an executed first sub-task, reducing the interaction with a disk in a data computing stage. Meanwhile, since the result data is stored in the memory, a network card of the first device can directly transmit the result data in the memory to a network card of a second device through network, also reducing the interaction with a disk and the consumption of computing resources in a data shuffling stage. The above method reduces the consumption of computing resources in both the data computing stage and the data shuffling stage, and shortens the execution duration of the distributed task, which facilitates execution of a distributed task having a high real time requirement.

Described above are particular embodiments of the embodiments of this specification. Other embodiments are within the scope of the appended claims. In some cases, actions or steps recited in the claims can be executed in an order different from that in the embodiments and still can achieve desired results. Additionally, the processes depicted in the drawings do not necessarily require a particular order as shown, or a consecutive order, to achieve the desired results. In certain implementations, multitasking and parallel processing are also possible or may be advantageous.

Upon consideration of the specification and practice of the invention as claimed here, those skilled in the art will readily envisage other implementations of the embodiments of this specification. The embodiments of this specification are intended to cover any variants, uses or adaptative changes of the embodiments of this specification, and these variants, uses or adaptive changes follow the general principles of the embodiments of this specification and include the common general knowledge or customary technical means in this technical field not claimed in the embodiments of this specification. The specification and embodiments are considered as exemplary only, and the true scope and spirit of the embodiments of this specification are pointed out in the following claims.

1. A distributed task processing method, wherein a distributed task comprises at least two sub-tasks respectively executed by at least two devices in a distributed system, wherein the at least two devices of the distributed system comprise a first device; the method comprising:
reading, by a processor of the first device, data in a memory of the first device to execute a first sub-task corresponding to the first device, obtaining and storing result data of the first sub-task in the memory of the first device; and
transmitting, by a network card of the first device, the result data of the first sub-task in the memory of the first device to a network card of a second device of the distributed system through network, such that the network card of the second device writes the result data of the first sub-task in a memory of the second device.

2. The method according to claim 1, wherein that the network card of the second device writes the result data of the first sub-task in the memory of the second device comprises:
reading, by a processor of the second device, the result data in the memory of the second device to execute a second sub-task corresponding to the second device; and/or transmitting, by the network card of the second device, the result data in the memory of the second device to a network card of a third device in the distributed system through network, such that the third device utilizes the result data to execute a third sub-task corresponding to the third device.

3. The method according to claim 2, wherein after the network card of the second device writes the result data of the first sub-task in the memory of the second device, the method further comprises:
sequentially writing, by the processor of the second device, the result data in the memory of the second device in a disk of the second device.

4. The method according to claim 3, wherein after sequentially writing, by the processor of the second device, the result data in the memory of the second device in the disk of the second device, the method further comprises:
deleting, by the processor of the second device, the result data in the memory of the second device; and
sequentially reading, after the processor of the second device receives a result data sending instruction, the result data from the disk of the second device to the memory of the second device, such that the network card of the second device transmits the result data in the memory of the second device to the network card of the third device in the distributed system through network.

5. The method according to claim 1, wherein a storage area of the memory of the first device comprises a sub-area for storing application data; the result data of the first sub-task is stored in the sub-area of the memory; and transmitting, by the network card of the first device, the result data of the first sub-task in the memory of the first device to the network card of the second device in the distributed system through network comprises:
transmitting, by the network card of the first device, the result data in the sub-area of the memory to the network card of the second device through remote direct access technology.

6. A distributed system for executing a distributed task, wherein the distributed system comprises at least two devices comprising a first device; the distributed task comprises at least two sub-tasks respectively executed by the at least two devices;
a processor of the first device is used for reading data in a memory of the first device to execute a first sub-task corresponding to the first device, obtaining and storing result data of the first sub-task in the memory of the first device;
a network card of the first device is used for transmitting the result data of the first sub-task in the memory of the first device to a network card of a second device of the distributed system through network; and
a network card of the second device is used for receiving the result data of the first sub-task and writing the result data of the first sub-task in a memory of the second device.

7. The system according to claim 6, wherein a processor of the second device is used for reading the result data in the memory of the second device to execute a second sub-task corresponding to the second device; and/or
the network card of the second device is used for transmitting the result data in the memory of the second device to a network card of a third device in the distributed system through network, such that the third device utilizes the result data to execute a third sub-task corresponding to the third device.

8. The system according to claim 7, wherein the processor of the second device is further used for sequentially writing the result data in the memory of the second device in a disk of the second device.

9. The system according to claim 8, wherein the processor of the second device is further used for deleting the result data in the memory of the second device; and sequentially reading, after receiving a result data sending instruction, the result data from the disk of the second device to the memory of the second device, such that the network card of the second device transmits the result data in the memory of the second device to the network card of the third device in the distributed system through network.

10. The system according to claim 6, wherein a storage area of the memory of the first device comprises a sub-area for storing application data; and the result data of the first sub-task is stored in the sub-area of the memory, and
the network card of the first device is further used for transmitting the result data in the sub-area of the memory to the network card of the second device through remote direct access technology.

11. A first device of a distributed system for executing a distributed task, wherein the distributed system comprises at least two devices comprising the first device; the distributed task comprises at least two sub-tasks respectively executed by the at least two devices; the first device comprises:
a processor;
a memory for storing processor executable instructions;
a network card; and
a memory;
wherein the processor is configured to read data in the memory of the first device to execute a first sub-task corresponding to the first device, obtain and store result data of the first sub-task in the memory of the first device; and
the network card is configured to transmit the result data of the first sub-task in the memory of the first device to a network card of a second device of the distributed system through network, such that the network card of the second device writes the result data of the first sub-task in a memory of the second device.

12. A computer program product comprising a computer program which, when executed by a processor, implements steps of the method according to claim 1.

13. A non-transitory computer readable storage medium having computer instructions stored thereon which, when executed, execute the method according to claim 1.

14. The computer program product according to claim 12, wherein the network card of the second device writes the result data of the first sub-task in the memory of the second device, and the processor of the second device sequentially writes the result data in the memory of the second device in a disk of the second device.

15. The computer program product according to claim 12, wherein after the network card of the second device writes the result data of the first sub-task in the memory of the second device, the processor of the second device sequentially writes the result data in the memory of the second device in a disk of the second device.

16. The computer program product according to claim 12, wherein after the processor sequentially writes the result data in the memory of the second device in the disk of the second device, the processor of the second device deletes the result data in the memory of the second device; and after the processor of the second device receives a result data sending instruction, the processor sequentially reads the result data from the disk of the second device to the memory of the second device, such that the network card of the second device transmits the result data in the memory of the second device to the network card of the third device in the distributed system through network.

17. The computer program product according to claim 12, wherein a storage area of the memory of the first device comprises a sub-area for storing application data; the result data of the first sub-task is stored in the sub-area of the memory; and the network card of the first device transmits the result data of the first sub-task in the memory of the first device to the network card of the second device in the distributed system through network, and the network card of the first device transmits the result data in the sub-area of the memory to the network card of the second device through remote direct access technology.

18. The non-transitory computer readable storage medium according to claim 13, wherein the network card of the second device writes the result data of the first sub-task in the memory of the second device, and a processor of the second device reads the result data in the memory of the second device to execute a second sub-task corresponding to the second device; and/or the network card of the second device transmits the result data in the memory of the second device to a network card of a third device in the distributed system through network, such that the third device utilizes the result data to execute a third sub-task corresponding to the third device.

19. The non-transitory computer readable storage medium according to claim 13, wherein the network card of the second device writes the result data of the first sub-task in the memory of the second device, a processor of the second device reads the result data in the memory of the second device to execute a second sub-task corresponding to the second device; and/or the network card of the second device transmits the result data in the memory of the second device to a network card of a third device in the distributed system through network, such that the third device utilizes the result data to execute a third sub-task corresponding to the third device.

20. The non-transitory computer readable storage medium according to claim 13, wherein after sequentially writing, by the processor of the second device, the result data in the memory of the second device in the disk of the second device, the processor of the second device deletes the result data in the memory of the second device; and after the processor of the second device receives a result data sending instruction, the processor sequentially reads the result data from the disk of the second device to the memory of the second device, such that the network card of the second device transmits the result data in the memory of the second device to the network card of the third device in the distributed system through network.
